(19) United States
(12) Patent Application Publication
(10) Pub. No.: US 2022/0089403 A1
(43) Pub. Date: Mar. 24, 2022

(54) BOLTLESS REEL WITH PAPERBOARD DRUM AND MOLDED FLANGES

(71) Applicant: Sonoco Development, Inc., Hartsville, SC (US)

(72) Inventor: Harvey Charles Echols, JR., Bastrop, LA (US)

(73) Assignee: Sonoco Development, Inc., Hartsville, SC (US)

(21) Appl. No.: 17/028,391

(22) Filed: Sep. 22, 2020

(51) Int. Cl. B65H 75/14; B65H 75/50; B29C 43/14; B29C 65/48

(52) U.S. Cl. CPC B65H 75/14; B65H 75/50; B29L 2031/704; B29C 65/48; B65H 2401/10; B29C 43/14

(57) ABSTRACT

A reel for carrying cable, wire or other wound materials is provided. The reel comprises a paperboard drum and molded flanges. The drum forms a friction fit with a hub located on each flange and forms an adhesive bond at an annular groove defined by each flange. The friction fit and the adhesive bond secure the flange to the drum sufficiently to eliminate the need for bolts or other attachment means.

### BACKGROUND OF THE INVENTION

### Field of the Invention

This disclosure relates to a reel for winding cable and wire. More particularly, this disclosure relates to a boltless reel having a paperboard drum and molded flanges and a method of making same.

### Description of the Related Art

Steel bolted plywood reels commonly are used to hold wire and cable. The steel bolted plywood reels typically comprise a drum made of wood or plastic and plywood flanges. The flanges are typically bolted together axially to hold the drum within a circumferential detent located on the inner facing surface of each flange. Steel bolted plywood reels can be difficult to assemble, and the cost of the assembled reel can be high.

Used plywood reels must be taken apart before the flanges or drums can be recycled. The remaining steel bolts must be recycled in a separate recycling stream. Because of the complexity of disassembling most current bolted plywood reels, many reels are going direct to landfills and are not 100% biodegradable.

The present disclosure addresses these needs and concerns by providing a reel having a paperboard drum and molded flanges.

### BRIEF SUMMARY OF THE INVENTION

The present disclosure relates to a reel for carrying cable, wire or other wound materials. The reel comprises a paperboard drum and molded flanges. The drum forms a friction fit with a hub located on each flange and forms an adhesive bond at an annular groove defined by each flange. The friction fit and the adhesive bond secure the flange to the drum sufficiently to eliminate the need for bolts or other attachment means.

In one embodiment, a reel is provided comprising a hollow cylindrical drum and two flanges. The drum is made from paperboard and is configured to receive strand or sheet material thereon. The drum defines an axis about which the drum can rotate. The drum has a central bore and a drum inner surface defining a drum inner diameter (DID) and an outer surface defining a drum outer diameter. The drum extends axially from a first drum end to an opposite, second drum end. A first flange is affixed to the first drum end and a second flange is affixed to the second drum end by friction and adhesive only. Each flange may be made from molded waste wood and a binder. Each flange has a circular rim, a flange inner surface and a flange outer surface spaced axially apart from the inner surface. Each flange further comprises a centrally located, annular hub, the hub having an outer perimeter surface for receiving the drum in a friction fit therewith. The hub may have a hub outer diameter (HOD) substantially equal to the drum inner diameter (DID). Each flange inner surface defines an annular groove located circumferentially around the hub and configured to receive an end of the drum. The end of the drum is adhered to the groove with glue or other adhesive. The friction fit and adhesive secure the flanges to the drum sufficiently to eliminate the need for bolts or other attachment means.

In another embodiment, a reel is provided consisting essentially of a hollow cylindrical drum, two flanges and adhesive. The drum may be made from paperboard and is configured to receive strand or sheet material thereon. A first flange is affixed to the first drum end and a second flange is affixed to the second drum end. Each flange has a centrally located annular hub extending inwardly (toward the drum) from the inner major face of the flange. The hub has an outer perimeter surface for receiving the drum in a friction fit therewith. In addition, each flange inner (major) surface defines an annular groove located circumferentially around the hub and configured to receive an of the drum. The adhesive may be disposed in the annular groove for adhering the flanges to the drum.

In another aspect a method of making a boltless reel is provided. The method may comprise the steps of:

forming a hollow cylindrical drum from paperboard, the drum configured to receive strand or sheet material thereon, the drum defining an axis about which the drum can rotate, the drum having a central bore that extends axially from a first drum end to an opposite, second drum end;

molding a first flange from waste wood and a binder, the first flange having a circular rim and having a flange inner surface and a flange outer surface spaced axially apart from the flange inner surface, the first flange further comprising a centrally located hub extending from the flange inner surface and having an outer perimeter surface and a hub outer diameter, the flange inner surface defining an annular groove located around the hub and configured to receive a first end of the drum, wherein the molding comprises
drying the waste wood to produce dry waste wood;
mixing the dry waste wood with the binder to make a mixture; and
compressing the mixture in a mold cavity at a pressure and temperature to form the first flange;

positioning the drum over the hub until the first end is inserted into the annular groove and the drum and the hub outer perimeter surface form a friction fit;

adhering the first flange to the first end using adhesive; and

molding a second flange in the same manner as the first flange and attaching the second flange to the second end of the drum in the same manner as the first flange; wherein

the friction fit and adhesive secure the flanges to the drum sufficiently to eliminate the need for bolts or other attachment means.

### BRIEF DESCRIPTION OF THE DRAWINGS

FIG. 1 is perspective view of a reel according to the disclosure.

FIG. 2 is a side plan view of a flange used to make the reel of FIG. 1.

FIG. 3 is a cross sectional view of the flange of FIG. 2 taken along line 3-3.

FIG. 4 is a side plan view of another flange according to the disclosure.

FIG. 5 is a cross sectional view of the flange of FIG. 4 taken along line 5-5.

FIG. 6 is a flowchart illustrating a method of making a reel according to the disclosure.

### DETAILED DESCRIPTION OF THE INVENTION

While the invention described herein may be embodied in many forms, there is shown in the drawings and will herein be described in detail one or more embodiments with the understanding that this disclosure is to be considered an exemplification of the principles of the invention and is not intended to limit the disclosure to the illustrated embodiments. Aspects of the different embodiments can be combined with or substituted for one another.

As will be appreciated, terms such as “inner”, “outer” and “over” (etc.), used as nouns, adjectives or adverbs refer in this description to the orientation of the structure of the reel as it is illustrated in the various views. Such terms are not intended to limit the invention to a particular orientation.

### Reel

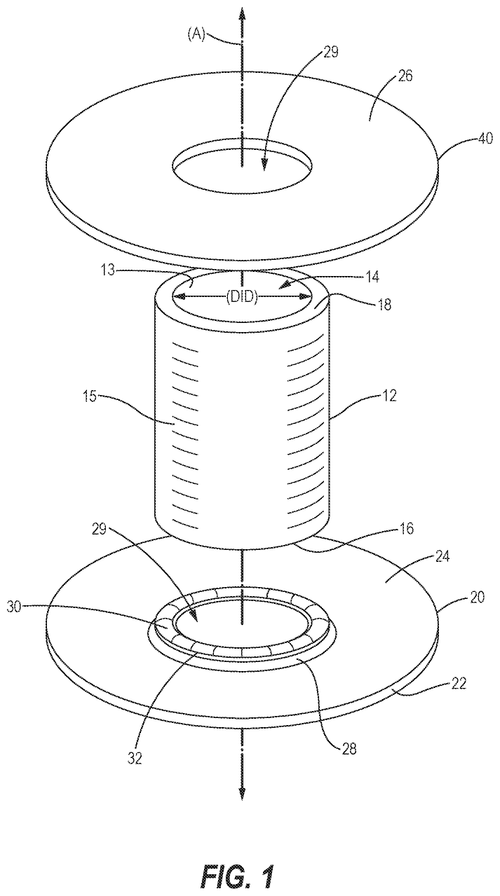

Turning to the drawings, where like numerals indicate like elements, there is shown in FIG. 1 one embodiment of a reel 10 according to the disclosure. The reel can carry cable, wire or other wound materials. The reel 10 lacks any bolts or other external attachment means and comprises a paperboard drum 12, a molded first flange 20 and a molded second flange 40.

The drum 12 may be made from paperboard and, more particularly, convolutely wound kraft paper to define a rigid yet inexpensive and structurally stable unit. The drum 12 may be hollow and cylindrical, and defines an axis (A) about which the drum 12 can rotate. The drum 12 has a central bore 14 having a drum inner surface 13 defining a drum inner diameter (DID), and an outer surface 15 defining a drum outer diameter (DOD). The drum 12 extends axially from a first drum end 16 to an opposite, second drum end 18.

The first flange 20 is affixed the first drum end 16. The second flange 40 is affixed to the second drum end 18. The first and second flanges 20, 40 may or may not be substantially identical. In the discussion that follows the description of the first flange 20 may apply equally to the second flange 40.

The first flange 20 may be made from molded waste wood and a binder. The first flange 20 may have a circular rim 22, a flange inner surface 24 and a flange outer surface 26 spaced axially apart from the inner surface 24. The first flange 20 may further comprise a centrally located, annular hub 30. For example, the first flange 20 may define a central opening 29 and the hub 30 may be disposed around the central opening 29.

The hub 30 may have an outer perimeter surface 32 for receiving (mating with) the drum inner surface 13 in a friction fit therewith. To facilitate the friction fit, the hub 30 may have a hub outer diameter (HOD) substantially equal to the drum inner diameter (DID).

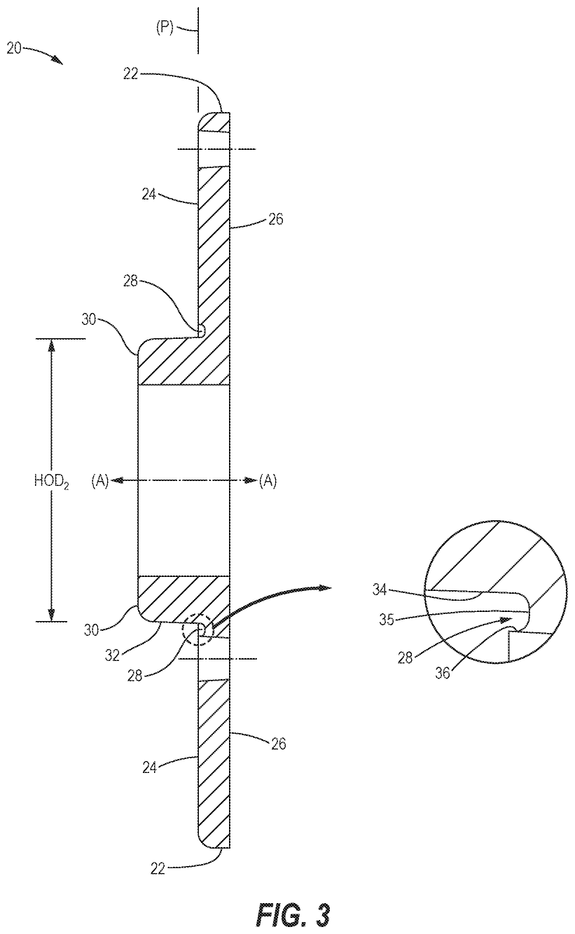

The flange inner surface 24 defines an annular groove 28 located circumferentially around the hub 30 and configured to receive an end 16,18 of the drum 12. As best shown in the inset to FIG. 3, the annular groove 28 is defined by an inner circumferential wall 34, a bottom wall 35 and an outer circumferential wall 36. Preferably, the inner circumferential wall 34 is axial extension of the outer perimeter surface 32 of the hub 30 such that the diameter of the inner circumferential wall 34 is the same as the diameter of the outer perimeter surface 32 of the hub 30. In this way, the drum inner surface 13 near the first end 16 is in contact with both the outer perimeter surface 32 of the hub 30 and the inner circumferential wall 34 in the assembled reel 10, while the drum outer surface 15 near the first end 16 contacts the outer circumferential wall 36. The end 16 of the drum may be adhered to the annular groove 28 with adhesive.

The friction fit and the adhesive secure the flange 20 to the drum 12 sufficiently to eliminate the need for bolts or other attachment means. In other words, the reel 10 may consist essentially of a paperboard drum 12, a molded first flange 20, a molded second flange 40 and adhesive disposed in the annular groove 28 for adhering the flanges 20, 40 to the drum 12.

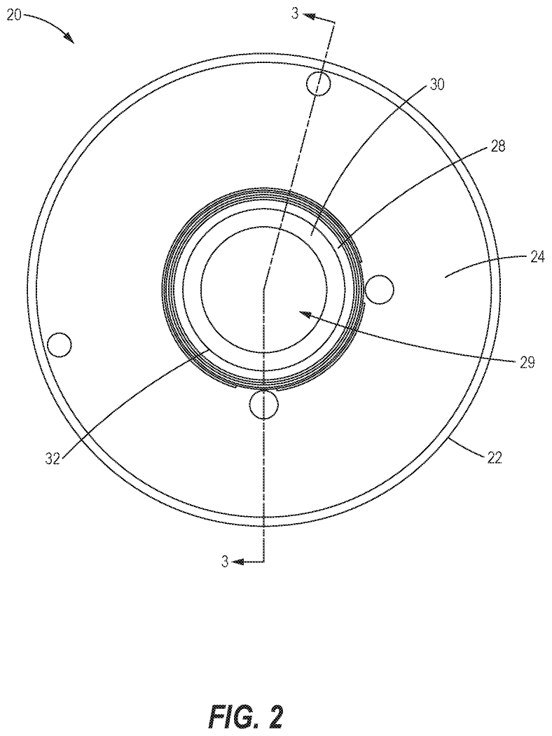

FIG. 2 is a side plan view of a first flange 20 used to make the reel 10 of FIG. 1. The annular hub 30 extends from the flange inner surface 24 in the direction of the viewer.

FIG. 3 is a cross sectional view of the first flange 20 of FIG. 2 taken along line 3-3. From this view it can be seen that the rim 22 may be rounded. In this embodiment the hub 30 extends outward from the plane (P) defined by the flange inner surface 24.

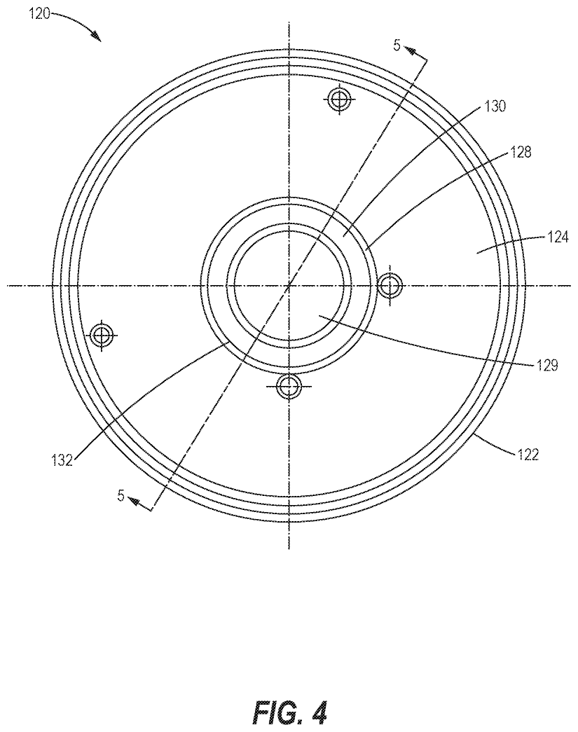

FIG. 4 is a side plan view of an alternative embodiment of a flange 120 according to the disclosure. As in the previous embodiment, the flange 120 may be made from molded waste wood and a binder. The flange 120 may have a circular rim 122, a flange inner surface 124 and a flange outer surface 126 spaced axially apart from the inner surface 124. The flange 120 may further comprise a centrally located, annular hub 130. The flange 120 may define a central opening 129 and the hub 130 may be disposed around the central opening 129.

The hub 130 may have an outer edge 132 for receiving the drum 12 in a friction fit therewith. To facilitate the friction fit, the hub 130 may have a hub outer diameter (HOD₂) substantially equal to the drum inner diameter (DID).

The flange inner surface 124 defines an annular groove 128 located circumferentially around the hub 130 and configured to receive an end 16,18 of the drum 12. The end 16,18 of the drum may be adhered to the annular groove 128 with adhesive. The friction fit and the adhesive secure the flange 120 to the drum 12 sufficiently to eliminate the need for bolts or other attachment means.

While a boltless reel is preferred, the reel 10 may comprise a plurality (two, three or more) small wood screws (not shown in the figures) extending radially through the drum 12 and into the hub 30 to add further strengthening to the adhesive joint.

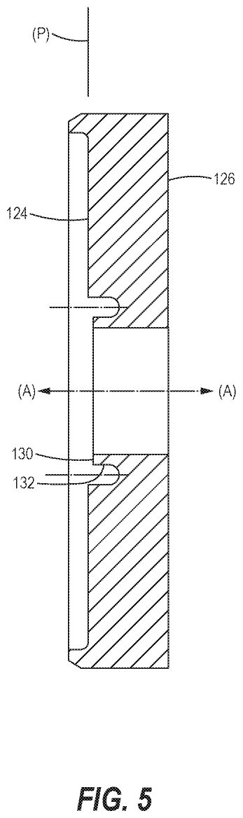

FIG. 5 is a cross sectional view of the flange 120 of FIG. 4 taken along line 5-5. From this view it can be seen that the rim 122 extends inward from the inner surface 124 of the flange 130 and is beveled.

In contrast to the previous embodiment shown in FIGS. 1-3, the hub 130 does not extend outward from the plane (P) defined by the flange inner surface 124, but rather is countersunk or depressed below the plane (P). This configuration is achieved by creating a groove 130 that extends a distance below the plane (P) of the inner surface 124 that is greater than the height of the hub 130. This, when an end 16, 18 of the drum 12 is inserted into the groove 130 the drum 12 can still form a friction fit with the outer edge 132 of the hub 130.

### Method of Making a Reel

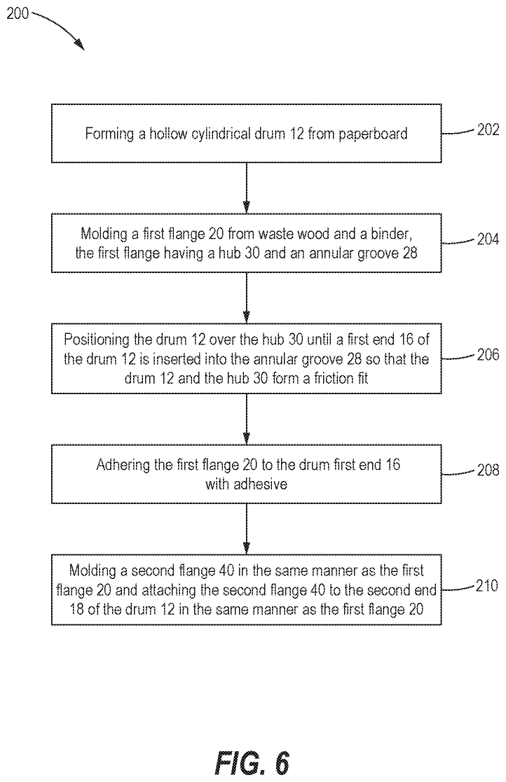

FIG. 6 is a flowchart illustrating a method 200 of making a boltless reel according to the disclosure. The method may comprise the following steps:

Step 202: Forming a hollow cylindrical drum 12 from paperboard. The drum 12 may be configured to receive strand or sheet material thereon. The drum 12 defines an axis (A) about which the drum 12 can rotate, and has a central bore 14 that extends axially from a first drum end 16 to an opposite, second drum end 18.

Step 204: Molding a first flange 20 from waste wood and a binder. The first flange 20 may have a circular rim 22 with rounded edges and a flange inner surface 24 and a flange outer surface 26 spaced axially apart from the flange inner surface 24. The first flange 20 may further comprise a centrally located annular hub 30 having an outer perimeter surface 32 and a hub outer diameter (HOD). The flange inner surface 24 defines an annular groove 28 located circumferentially around the hub 30 and configured to receive a first end 16 of the drum 12.

The molding process may comprise drying the waste wood to produce dry waste wood; mixing the dry waste wood with the binder to make a mixture; and compressing the mixture in a mold cavity at a pressure and temperature to form the first flange 20;

Step 206: Positioning the drum 12 over the hub 30 until the first end 16 is inserted into the annular groove 28 and the drum 12 and the hub outer perimeter surface 32 form a friction fit.

Step 208: Adhering the drum first end 16 to the first flange 20 using adhesive. More particularly, adhering the drum first end 16 to the annular groove 28, preferably to the inner circumferential wall 34, the bottom wall 35 and the outer circumferential wall 36, with adhesive.

Step 210: Molding a second flange 40 in the same manner as the first flange 20 and attaching the second flange 40 to the second end 18 of the drum 12 in the same manner as the first flange 20.

The method 200 requires that the friction fit and the adhesive secure the flanges 20, 40 to the drum 12 sufficiently to eliminate the need for bolts or other attachment means.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A reel comprising:
a hollow cylindrical drum made from paperboard, the drum configured to receive strand or sheet material thereon, the drum defining an axis (A) about which the drum can rotate, the drum having a central bore and a drum inner surface defining a drum inner diameter (DID) and an outer surface defining a drum outer diameter (DOD), the drum extending axially from a first drum end to an opposite, second drum end;
a first flange affixed to the first drum end; and
a second flange affixed to the second drum end; wherein
each flange is made from molded waste wood and a binder;
each flange has a circular rim, a flange inner surface and a flange outer surface spaced axially apart from the inner surface;
each flange further comprises a centrally located, annular hub, the hub having an outer perimeter surface for receiving the drum in a friction fit therewith, the hub having a hub outer diameter (HOD) substantially equal to the drum inner diameter (DID);
each flange inner surface defines an annular groove located circumferentially around the hub and configured to receive an end of the drum, the end of the drum being adhered to the groove with adhesive; and
the friction fit and adhesive secure the flanges to the drum sufficiently to eliminate the need for bolts or other attachment means.

2. The reel of claim 1 wherein:
each flange defines a central opening; and
the hub is disposed around the central opening.

3. A reel consisting essentially of:
a hollow cylindrical drum made from paperboard, the drum configured to receive strand or sheet material thereon, the drum defining an axis (A) about which the drum can rotate, the drum having a central bore having a drum inner surface defining a drum inner diameter (DID) and an outer surface defining a drum outer diameter (DOD), the drum extending axially from a first drum end to an opposite, second drum end;
a first flange affixed to the first drum end and a second flange affixed to the second drum end, each flange having a circular rim, a flange inner surface and a flange outer surface spaced axially apart from the inner surface, each flange further comprising a centrally located annular hub, the hub having an outer perimeter surface for receiving the drum in a friction fit therewith, each flange inner surface defining an annular groove located circumferentially around the hub and configured to receive an end of the drum; and
adhesive disposed in the annular groove for adhering the flanges to the drum.

4. A method of making a boltless reel, the method comprising the steps of:
forming a hollow cylindrical drum from paperboard, the drum configured to receive strand or sheet material thereon, the drum defining an axis (A) about which the drum can rotate, the drum having a central bore that extends axially from a first drum end to an opposite, second drum end;
molding a first flange from waste wood and a binder, the first flange having a circular rim and having a flange inner surface and a flange outer surface spaced axially apart from the flange inner surface, the first flange further comprising a centrally located hub having an outer perimeter surface and a hub outer diameter (HOD), the flange inner surface defining an annular groove located around the hub and configured to receive a first end of the drum, wherein the molding comprises
drying the waste wood to produce dry waste wood;
mixing the dry waste wood with the binder to make a mixture; and
compressing the mixture in a mold cavity at a pressure and temperature to form the first flange;
positioning the drum over the hub until the first end is inserted into the annular groove and the drum and the hub outer perimeter surface form a friction fit;
adhering the first flange to the first end using adhesive; and
molding a second flange in the same manner as the first flange and attaching the second flange to the second end of the drum in the same manner as the first flange; wherein
the friction fit and adhesive secure the flanges to the drum sufficiently to eliminate the need for bolts or other attachment means.
